(19) United States
(12) Patent Application Publication
(10) Pub. No.: US 2002/0145118 A1
(43) Pub. Date: Oct. 10, 2002

(54) Detection of backscattered electrons from a substrate

(75) Inventor: Henry Pearce-Percy, Los Gatos, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 09/832,765

(22) Filed: Apr. 10, 2001

(51) Int. Cl. G01K 1/08; H01J 3/14; H01J 3/26

(52) U.S. Cl. 250/397

(57) ABSTRACT

A backscattered electron detector capable of detecting electrons backscattered from a substrate includes a p-n junction diode having a p-doped semiconductor in contact with an n-doped semiconductor and a surface to receive the backscattered electrons. The backscattered electron detector also has a diode voltage source adapted to electrically bias the diode relative to the substrate by a diode bias voltage of at least about 500 V to increase the number or energy level of the backscattered electrons received by the diode. A signal amplifier may be used to process an input signal from the diode and generate an output signal that is amplified and passed to a controller that uses the amplified signal to locate a fiducial mark on the substrate.

### BACKGROUND

Embodiments of the present invention relate to the detection of backscattered electrons from a substrate.

In the fabrication of electronic circuits, an electron beam pattern may be registered on a substrate using an electron beam. In one embodiment, for example, the substrate may be a mask blank having a resist layer that is patterned by the electron beam to fabricate a mask suitable for use in the photolithography of the electronic circuits. The requirements for the accuracy and resolution of the electron beam image to be registered on such a substrate keep increasing as the image pattern becomes finer or more complex. Imaging accuracy is especially a problem when registering multiple images over one another on a substrate using successive processing steps, such as for example, in the manufacture of multiple layer phase shift masks (PSM), where two or more imaging layers are patterned slightly differently so that the light passing through the layers interferes constructively or destructively to be transmitted as a high-resolution pattern onto the substrate.

However, it is difficult to achieve good imaging accuracy or reproducibility if the substrate is distorted or is misaligned during image registration. To correct for the substrate distortions and misalignments, the locations of a number of fiducial marks on a substrate are determined and compared to their intended locations. The fiducial marks serve as reference points, and may comprise, for example, a material different from the surrounding substrate material, such as a conducting or reflecting material, physical protrusions, steps or voids. For example, in the manufacture of masks for semiconductor fabrication, the fiducial marks are typically conductor plates that are located on or under the resist layer.

In one method of detecting the fiducial marks, an electron beam is directed onto the substrate, and an intensity of electrons that is backscattered from the substrate when the electron beam passes over a fiducial mark on the substrate, is detected by, for example, an electron detector diode. However, conventional electron detector diodes typically detect only the backscattered electrons that have an energy level higher than a threshold energy level of the detector diode, which may be for example, about 4 keV. The backscattered electrons that have lower energy levels do not penetrate into the active layer of the diode. Thus, a substantial percentage of the backscattered electrons are not detected by the diode detector, which results in a low signal to noise ratio for the fiducial mark locator, and resultant inaccuracies or errors in the image registration process.

Accordingly, it is desirable to detect a wider spectrum of energy levels of the backscattered electrons, including those electrons which are at lower energy levels. It is also desirable to have an electron detector that is capable of accurately detecting electrons with a high signal-to-noise ratio. It is further desirable to have an electron detector that may operate as a reliable fiducial mark locator.

### SUMMARY

A backscattered electron detector capable of detecting electrons that are backscattered from a substrate, comprises a p-n junction diode comprising a p-doped semiconductor contacting an n-doped semiconductor and having a surface adapted to receive the backscattered electrons, and a diode voltage source adapted to electrically bias the p-n junction diode relative to the substrate by a diode bias voltage of at least about 500 V to accelerate backscattered electrons between the substrate and the p-n junction diode.

A method of detecting backscattered electrons from a substrate, the method comprises directing an electron beam toward a substrate, whereby at least some of the electrons are backscattered by the substrate, electrically biasing a p-n junction diode relative to the substrate by a diode bias voltage of at least about 500 V to accelerate backscattered electrons from the substrate to the p-n junction diode, and detecting a signal from the p-n junction diode.

An electron beam image registration apparatus comprises a vacuum chamber comprising a vacuum pump, a support capable of supporting a substrate in the vacuum chamber, the substrate having one or more fiducial marks thereon, an electron beam source component to generate an electron beam that is directed onto the substrate, whereby at least some of the electrons are backscattered by the substrate, an electron beam modulating component to modulate the electron beam, an electron beam scanning component to scan the electron beam across the substrate to register an electron beam image on the substrate, a backscattered electron detector capable of detecting the electrons backscattered by the substrate, the detector comprising (a) a p-n junction diode comprising a p-doped semiconductor contacting an n-doped semiconductor and a surface adapted to receive the backscattered electrons; (b) a diode voltage source adapted to electrically bias the p-n junction diode relative to the substrate by a diode bias voltage of at least about 500 V to accelerate the backscattered electrons between the substrate and the p-n junction diode, and (c) a signal amplifier to process an input signal from the p-n junction diode and generate an output signal, and a controller capable of determining the locations of one or more of the fiducial marks on the substrate from the output signal of the signal amplifier.

An electron beam image registration method comprises providing a substrate having fiducial marks; generating, modulating and scanning an electron beam across the substrate to register an electron beam image on the substrate, whereby at least some electrons are backscattered by the substrate; electrically biasing a p-n junction diode relative to the substrate by a diode bias voltage of at least about 500 V to accelerate backscattered electrons from the substrate to the p-n junction diode; detecting a signal from the p-n junction diode and processing the signal to determine the locations of one or more of the fiducial marks on the substrate.

### DRAWINGS

These features, aspects, and advantages of the present invention will become better understood with regard to the following description, appended claims, and accompanying drawings which illustrate examples of the invention. However, it is to be understood that each of the features can be used in the invention in general, not merely in the context of the particular drawings, and the invention includes any combination of these features, where:

FIG. 1 is a side view of an embodiment of a backscattered electron detector according to the present invention, showing the detector detecting electrons being backscattered by a fiducial mark on the substrate;

FIG. 2 is a side view of another embodiment of a backscattered electron detector according to the present invention; and

FIG. 3 is a side view of an electron beam image registration apparatus according to the present invention.

### DESCRIPTION

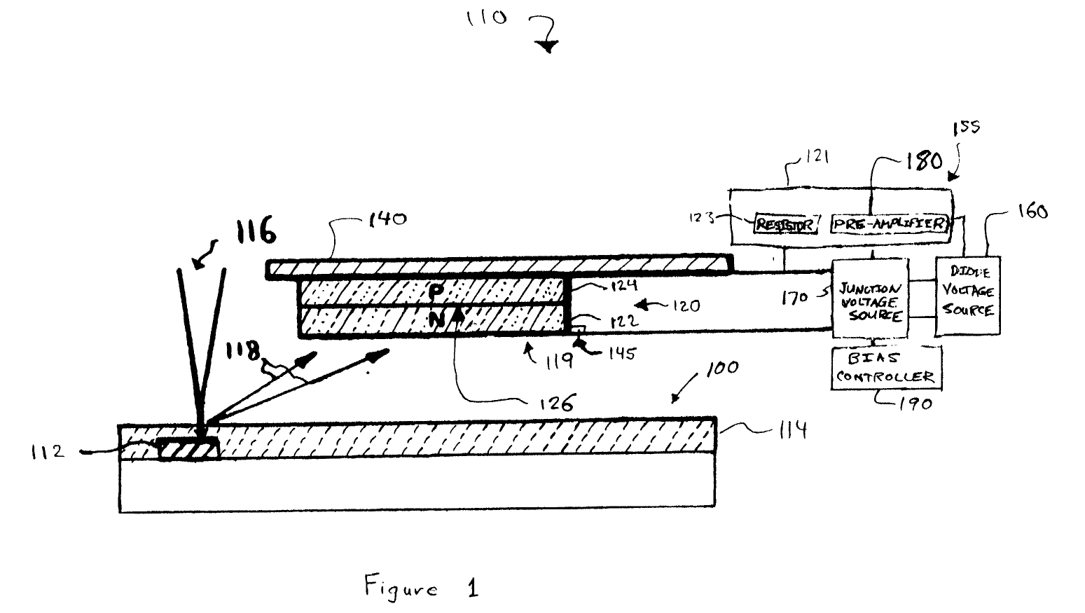

A backscattered electron detector 110 according to an embodiment of the present invention is useful for detecting backscattered electrons. In an exemplary version, as illustrated in FIG. 1, the backscattered electron detector 110 serves as a fiducial mark locator that may be used to locate a fiducial mark 112 of a substrate 100 in the fabrication of, for example, a semiconductor chip mask or a printed circuit board. However, the backscattered electron detector 110 may also be used for other applications, for example, to inspect defects on the substrate 100, to determine the location of an electron beam directed onto the substrate 100, or for other uses as would be apparent to one of ordinary skill in the art.

Generally, the substrate 100 comprises one or more dielectric, semiconductor, or conductor materials. The substrate 100 may comprise a resist layer 114 capable of recording an image, and which may be of a negative or a positive type, according to whether polymer cross-linking or polymer chain scission, respectively, occur. The substrate may be, for example, a quartz plate coated with a resist layer to serve as a mask to register images of circuitry to be transferred to an integrated circuit device. After registering the image on the substrate 100, a developing solvent may be used to remove selected material from the substrate 100. For a negative resist, a developing solvent is used to remove the unexposed resist, and for a positive resist, a developing solvent is used to remove the exposed resist. The developing solvent may comprise a gas (“dry etching”) or liquid (“wet etching”), where gas is sometimes preferable partially because it may provide more uniform etching characteristics.

The fiducial marks 112 of the substrate 100 may comprise inhomogeneities in the substrate 100, such as those formed by a different material, a protrusion, or a cavity. In one version, the fiducial marks 112 of the substrate 100 comprise a conductor, such as a metal, for example, aluminum. The fiducial marks 112 may have a shape suitable to be detected, such as a dot or rectangle. The fiducial marks 112 are placed in or on the substrate 100 according to intended fiducial mark locations. The fiducial marks 112 are subsequently located to yield measured fiducial mark locations. The fiducial mark deviations between the intended fiducial mark locations and the measured fiducial mark locations yield information about properties of the substrate 100 that would cause mis-registration if they were not accounted for, such as misalignment or distortion of the substrate 100.

The fiducial mark deviations may be used to calculate a correction operator to more correctly register an image on the substrate 100. The correction operator may comprise a correction mapping or a set of alignment corrections. A correction mapping is a transformation factor, such as a matrix of transformation values, that embodies the deviation between the intended location of each fiducial mark 112 and its measured location on the substrate 100 in relation to an image that is to be registered on the substrate 100. The form of the correction mapping may be predetermined or automatically determined during the image registration process. The correction mapping may comprise one or more of scaling, rotational, or offset values. In one version, the correction operator is applied to the image in its vector or bitmapped form. In an alternative version, the correction operator is applied during registration by a hardware filter. In either version, a corrected image is registered on the substrate 100. A set of alignment corrections may comprise, for example, x and y offsets, a rotational offset, or a vertical offset.

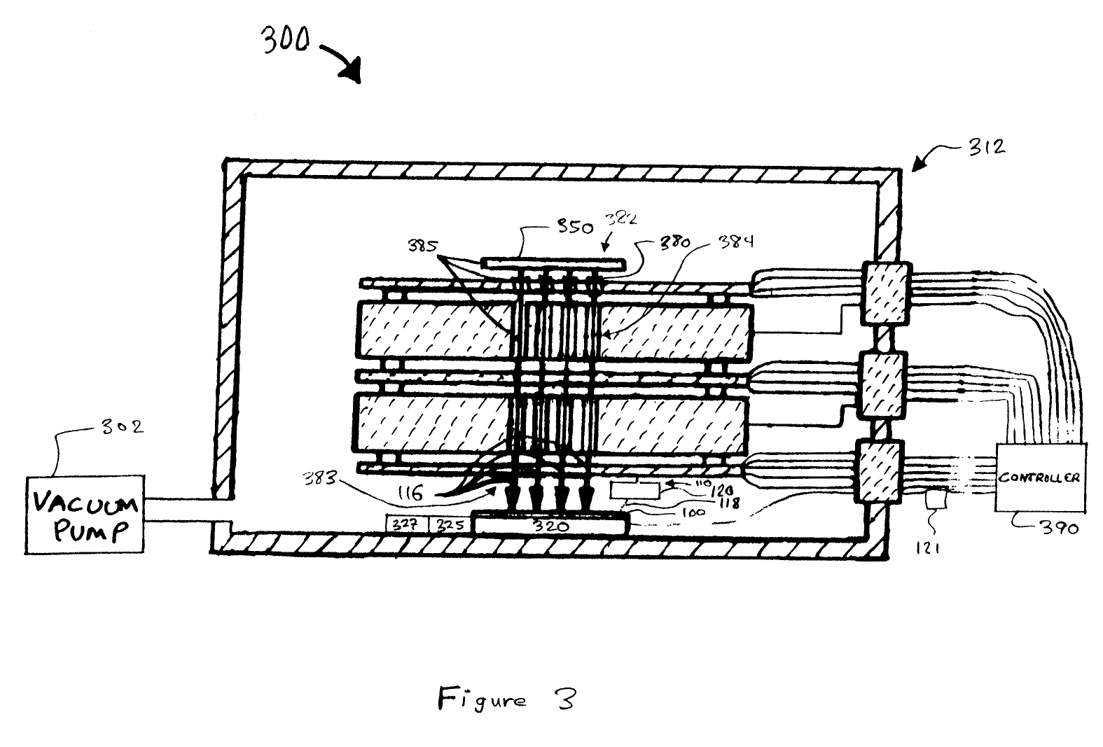

In operation, an electron beam source 350 as shown in FIG. 3 provides an electron beam 116 that is directed toward the substrate 100. The electron beam 116 has an energy intensity suitable for locating the fiducial mark 112 shown in FIG. 1. For example, the electron beam source 350 may be used in the registration of an image on the substrate 100. A suitable electron beam source 350 for electron beam image registration is capable of generating an electron beam 116 which typically has an energy level in excess of about 10 keV, and more typically from about 50 keV to about 100 keV. Alternatively, the electron beam source 350 may also be dedicated for fiducial mark location. The dedicated electron beam source 350 (not shown) may generate an electron beam having a lower energy level and may also be positioned closer to the substrate 100.

The backscattered electron detector 110 may serve as a fiducial mark locator to locate the fiducial marks 112 by detecting the changes in the number or energy level of the electrons 118 that are backscattered from the substrate 100. The number or energy level of the backscattered electrons 118 varies depending on whether the electron beam 116 impinges on the substrate 100 in a location on or near a fiducial mark 112 or in a location substantially away from a fiducial mark 112. For example, a larger number of electrons 118 are backscattered when the electron beam 116 impinges on the fiducial mark 112, relative to the number of electrons backscattered from the other portions of the substrate 100. Thus, by detecting the changes in the levels of backscattered electrons received by the detector 110, the locations of the fiducial marks may be determined.

Generally, the backscattered electron detector 110 comprises a p-n junction diode 120 that generates an electrical signal comprising an electrical current when backscattered electrons 118 impinge upon and are received by the p-n junction diode 120. The p-n junction diode 120 comprises a p-doped semiconductor 124 and an n-doped semiconductor 122 contacting one another to define a p-n junction 126. The p-doped semiconductor 124 comprises a semiconductor, such as silicon or germanium, doped with an “acceptor” material that has a lower number of valence electrons than the semiconductor, such as boron. The n-doped semiconductor 122 comprises a semiconductor, such as silicon or germanium, doped with a “donor” material that has a higher number of valence electrons than the semiconductor, such as phosphorous.

The p-n junction diode 120 also comprises an electron-receiving surface 119 that is adapted to receive the backscattered electrons 118. In one embodiment, the electron-receiving surface 119 of the diode 120 is a surface of the n-doped semiconductor 122 that faces the substrate 100 so the diode 120 efficiently receives and converts the backscattered electrons 118 into the signal. The diode 120 may also be electrically connected to other circuitry at each of its two semiconductors 124, 122. For example, the diode 120 may be connected to a conducting plate 140 at the p-doped semiconductor 124 to provide a good connection to other circuitry. The diode 120 may also have a metal contact 145 at the n-doped semiconductor 122 to receive an electrical connection, such as an electrical wire or trace. The metal contact 145 may comprise an embedded conductor, solder, a latch, or a screw, to also make a good and reliable connection.

The p-n junction diode 120 may be operated in a conductive or a voltaic mode. In the conductive mode, in which the diode 120 typically has a faster response time, the p-n junction 126 of the diode 120 is reverse biased by a small junction bias voltage applied across the p-n junction 126 by a junction voltage source 170. The p-n junction 126 is reverse-biased by maintaining the p-doped semiconductor 124 at a lower voltage than the voltage at the n-doped semiconductor 122. A minimal leakage current may flow through the diode 120 when the backscattered electrons 118 do not impinge on the diode 120 and a larger current flows through when the backscattered electrons 118 actually impinge on the diode 120. A suitable junction bias voltage is from about 6 to about 10 Volts. In the voltaic mode, the p-n junction 126 is not biased so that a voltage is generated only when the backscattered electrons 118 are received by the diode 120 and reach the p-n junction 126.

The entire diode 120 may also be electrically biased relative to the substrate 100 by a diode bias voltage that is sufficiently high to accelerate low energy backscattered electrons 118 from the substrate 100 to the diode electron receiving surface 119. The diode bias voltage accelerates the backscattered electrons to kinetic energies that are greater than the threshold energy level of the diode 120 to allow more of the backscattered electrons to enter the diode 120. The diode bias voltage may be generated by a suitable diode voltage source 160 connected to the diode 120. The diode voltage source 160 may also be connected to a bias controller 190 that allows control of the applied diode bias voltage. For example, the bias controller 190 may comprise an on/off switch or a variable resistor for variable control of the applied diode bias voltage.

The diode bias voltage applied to bias the diode 120 relative to the substrate 100 may be at least as high as the threshold detection energy of the diode 120 to overcome the threshold detection energy. The larger number of energetic electrons 118 that are received by the diode 120 increase the operational signal to noise ratio of the diode 120. Generally, the value of the diode bias voltage applied depends upon the structure and material composition of the diode 120 and the value of the junction bias voltage, if any, applied across the p-n junction 126 of the diode 120. In one version, the diode bias voltage is at least about 500 V, and may even be at least about 1000 V, or even at least about 10000 V. A diode bias voltage sufficiently large to accelerate electrons 118 from the substrate 100 to the electron-receiving surface 119 to kinetic energies of at least about 5 keV is typically desirable because it is slightly greater than a typical threshold energy level of the diode 120. For example, a diode bias voltage of about 3000 V may be used to accelerate electrons 118 having kinetic energies of from about 2 keV to about 4 keV to kinetic energies of from about 5 keV to about 7 keV, at which they are detectable by the diode 120. Other electronic components 155 connected to the diode 120, such as the junction voltage source 170 or the signal amplifier 121, may also be biased, or “floated,” at the same voltage as the diode 120. The voltage bias in the signal coming from the diode 120 may be removed (i.e., the signal may be de-biased) before being processed by further components, such as electronic signal analysis components (not shown).

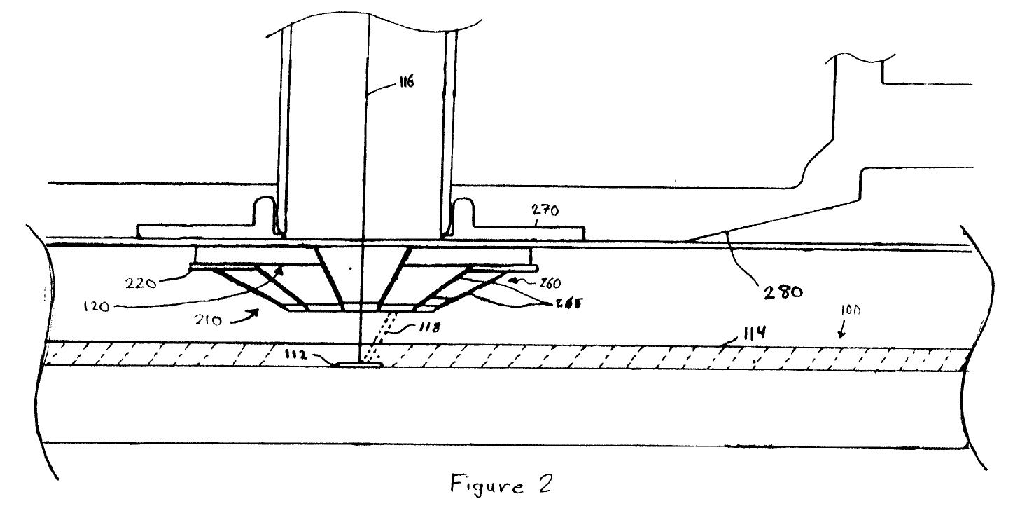

In one version, the p-n junction diode 120 is mounted in a detector assembly 210 that has a holder 220 adapted to hold the diode 120, as shown in FIG. 2. For example, the holder 220 may be shaped and sized to receive the p-n junction diode 120. The holder 220 may comprise a dielectric to isolate and insulate the diode 120 from the detector assembly 210. The dielectric may be made of, for example, a ceramic, which may also be desirable because it is substantially heat-resistant. The holder 220 may also comprise electrical connections, such as leads embedded inside the holder 220, to connect the p-doped semiconductor 124 and the n-doped semiconductor 122 shown in FIG. 1 to the diode voltage source 160 or the junction voltage source 170.

The detector assembly 210 shown in FIG. 2 may also comprise one or more grounded shields 260 to shield the electron beam 116 from the high voltage applied to the diode 120. The grounded shields 260 shield the electron beam 116 by drawing charge from ground to compensate for the electric field generated by the diode 120. The grounded shields 260 may additionally be shaped or positioned to trap backscattered electrons 118 that may otherwise deflect back toward the resist layer 114. If the electrons 118 accumulate on the resist 114, they may create an electric field that affects the path of the backscattered electrons 118 or the electron beam 116. The grounded shields 260 may comprise, for example, grounded concentric cones 265 that provide multiple openings exposed to the substrate 100 to trap the backscattered electrons 118. The detector assembly 210 may also be attached to a holder plate 270, which may be held in a lens pole piece 280.

The backscattered electron detector 110 shown in FIG. 1 further comprises a signal amplifier 121 to process an input signal from the p-n junction diode 120 and generate an output signal. The signal amplifier 121 converts the form of, may also amplify, the signal from the diode 120 so that the signal is suitable to locate a fiducial mark 112 on the substrate 100. The components of the signal amplifier 121 depend upon whether the p-n junction 126 of the diode 120 is operated in a conductive or voltaic mode. When the p-n junction is operated in the conductive mode, a suitable signal amplifier 121 comprises a resistor 123 and a pre-amplifier 180. The current may be converted to a voltage, for example, by the resistor 123, and the resulting voltage may be amplified by the pre-amplifier 180. A suitable pre-amplifier 180 is an operational amplifier. In the voltaic mode, the signal amplifier 121 comprises a pre-amplifier 180, such as an operational amplifier, suitable to amplify the voltage. In either mode, the backscattered electron signal generated by the diode 120 is in relation to the number or energy of the electrons 118 received by the p-n junction 126 and this signal is converted to an amplified voltage.

The backscattered electron detector 110 may be used to locate the fiducial marks 112 on the substrate 100 in an electron beam image registration apparatus 300, an exemplary version of which is illustrated in FIG. 3. The electron beam image registration apparatus 300 may be used to register an image on the substrate 100 to fabricate a mask that is used to project image patterns of electronic circuitry on a photomask or semiconductor wafer, and may be for example, a MEBES 5500™ machine from Etec, Inc., Hayward, Calif. However, the illustrative apparatus embodiment provided should not be used to limit the scope of the invention, and the invention encompasses equivalent or alternative versions, as would be apparent to one of ordinary skill in the art. For example, the backscattered electron detector 110 may also be used to locate fiducial marks 112 in a laser beam image registration apparatus capable of registering a laser beam image on the substrate 100.

The electron beam image registration apparatus 300 comprises electron beam source, modulating and scanning components 385 that are capable of generating, modulating, or scanning one or more electron beams 116 that are directed along a beam pathway 384 toward the substrate 100. The electron beam pathway 384 may be a straight line, a curved line, a series of connected straight lines, or any other path traversed by the beams 116. One or more of the electron beam components 385 may be arranged in a beam column 382. Thus, the beam column 382 may be vertically oriented as a straight column above the substrate 100 (as shown), may be oriented in an angled configuration (not shown), such as a right angled configuration, or may be oriented in a curved configuration (also not shown). The components 385 include an electron beam source component 350 to generate and direct the electron beams 116 toward the substrate 100, electron beam modulating components 380 to modulate the electron beams 116 according to an electron beam image, and electron beam scanning components 383 to scan the electron beams 116 across the substrate 100 to register the electron beam image on the substrate 100. The electron beam source 350 may comprise, for example, a photocathode, field emission electron emitter, thermionic emission electron emitter, negative electron affinity emission emitter, or hot electron tunneling emission emitter.

In an exemplary embodiment, the electron beam image registration apparatus 300 comprises a vacuum chamber 312 comprising, for example, aluminum walls, that is capable of enclosing a vacuum, and a connected vacuum pump 302 that is useful to evacuate the vacuum chamber 312 to create and maintain a vacuum therein. A support 320 is provided in the vacuum chamber 312 to support the substrate 100, and support motors 325 capable of moving the support 320 to move the substrate 100, for example, to position the substrate 100, or during scanning of the electron beams 116 across the substrate 100. The support motors 325 typically comprise electric motors that translate the support 320 in the x and y directions along an x-y plane parallel to the substrate surface, rotate the support 320, or tilt the support 320. The apparatus 300 may further comprise support position sensors 327 capable of precisely determining the position of the support 320. For example, the support position sensors 327 may reflect a light beam (not shown) from the support 320 and detect the reflected beam, where the distance between the support 320 and the support position sensors 327 is determined interferometrically.

The signal amplifier 121 may feed the amplified signal to a controller 390, which is adapted to determine the locations of the fiducial marks 112 shown in FIGS. 1 and 2 using the amplified signal. The controller 390 shown in FIG. 3 may also be capable of calculating the correction operator for the image to be more correctly registered on the substrate 100. Generally, the controller 390 comprises hardware, software, or programmable logic devices in a configuration adapted to receive data from the backscattered electron detector 110, calculate any deviation of the fiducial marks 112 by comparing the measured fiducial mark location to a predefined or stored intended location, calculate a correction mapping for the image using the fiducial mark deviations, and map the portion of the image to be registered on the substrate 100 by the correction mapping to a correction mapped image. For example, the controller 390 may be a computer that executes software of a computer-readable program residing on a computer system comprising a central processing unit (CPU), such as for example, a Pentium Processor commercially available from Intel Corporation, Santa Clara, Calif., that is coupled to a memory and peripheral computer components. The memory may comprise a computer-readable medium having the computer-readable program therein. The memory may comprise volatile or non-volatile memories. The memory may comprise magnetic memory such as a hard disk or floppy disk, optical memory such as a compact disc, or solid state memory such as RAM or ROM, suitable for storing fiducial mark locations, calculated mark fiducial deviations, correction mappings or corrected images.

The interface between an operator and the controller 390 can be, for example, via a monitor and a keyboard. Other computer-readable programs such as those stored on other memory including, for example, a magnetic disk or other computer program product inserted in a drive of the memory, may also be used to operate the controller 390. The computer system card rack may contain a single-board computer, analog and digital input/output boards, interface boards, and stepper motor controller boards. Various components of the apparatus conform to the Versa Modular European (VME) standard, which defines board, card cage, and connector dimensions and types.

The computer-readable program may generally comprise software comprising a set of instructions to operate the image registration apparatus 300. The computer-readable program can be written in any conventional programming language, such as for example, assembly language, C, C++ or Fortran. Suitable program code is entered into a single file, or multiple files, using a conventional text editor and stored or embodied in the memory of the computer system. If the entered code text is in a high level language, the code is compiled, and the resultant compiler code is then linked with an object code of pre-compiled library routines. To execute the linked, compiled object code, the user invokes the object code, causing the CPU to read and execute the code to perform the tasks identified in the program.

The present apparatus and method provides improved signal-to-noise ratio in a detected backscattered electron signal. Although the present invention has been described in considerable detail with regard to certain preferred versions thereof, other versions are possible. For example, the present invention could be used with other devices, such as non-image-registration devices, for example, electron-beam step-and-repeat cameras. Thus, the appended claims should not be limited to the description of the preferred versions contained herein.

What is claimed is:

1. A backscattered electron detector capable of detecting electrons that are backscattered from a substrate, the detector comprising:
a p-n junction diode comprising a p-doped semiconductor contacting an n-doped semiconductor and having a surface adapted to receive the backscattered electrons; and
a diode voltage source adapted to electrically bias the p-n junction diode relative to the substrate by a diode bias voltage of at least about 500 V to accelerate backscattered electrons between the substrate and the p-n junction diode.

2. A backscattered electron detector according to claim 1 wherein the diode bias voltage is sufficiently high to accelerate the backscattered electrons to kinetic energies of at least about 5 keV.

3. A backscattered electron detector according to claim 1 wherein the diode bias voltage is sufficiently high to accelerate backscattered electrons having kinetic energies of from about 2 keV to about 4 keV to kinetic energies of from about 5 keV to about 7 keV.

4. A backscattered electron detector according to claim 1 wherein the diode bias voltage is at least about 1000 V.

5. A backscattered electron detector according to claim 4 wherein the diode bias voltage is less than about 10000 V.

6. A backscattered electron detector according to claim 1 comprising a dielectric holder to hold the p-n junction diode.

7. A backscattered electron detector according to claim 6 comprising one or more grounded shields surrounding the dielectric holder.

8. A backscattered electron detector according to claim 7 wherein the grounded shields comprise concentric cones.

9. A method of detecting backscattered electrons from a substrate, the method comprising:
(a) directing an electron beam toward a substrate, whereby at least some of the electrons are backscattered by the substrate;
(b) electrically biasing a p-n junction diode relative to the substrate by a diode bias voltage of at least about 500 V to accelerate backscattered electrons from the substrate to the p-n junction diode; and
(c) detecting a signal from the p-n junction diode.

10. A method according to claim 9 wherein the diode bias voltage is sufficiently high to accelerate the backscattered electrons to kinetic energies of at least about 5 keV.

11. A method according to claim 10 wherein the diode bias voltage is sufficiently high to accelerate backscattered electrons having kinetic energies of from about 2 keV to about 4 keV to kinetic energies of from about 5 keV to about 7 keV.

12. A method according to claim 9 wherein the diode bias voltage is at least about 1000 V.

13. A method according to claim 12 wherein the diode bias voltage is less than about 10000 V.

14. A method according to claim 9 wherein (c) comprises determining the location of a fiducial mark on the substrate from the detected signal.

15. An electron beam image registration apparatus comprising:
a vacuum chamber comprising a vacuum pump;
a support capable of supporting a substrate in the vacuum chamber, the substrate having one or more fiducial marks thereon;
an electron beam source component to generate an electron beam that is directed onto the substrate, whereby at least some of the electrons are backscattered by the substrate;
an electron beam modulating component to modulate the electron beam;
an electron beam scanning component to scan the electron beam across the substrate to register an electron beam image on the substrate;
a backscattered electron detector capable of detecting the electrons backscattered by the substrate, the detector comprising (a) a p-n junction diode comprising a p-doped semiconductor contacting an n-doped semiconductor and a surface adapted to receive the backscattered electrons; (b) a diode voltage source adapted to electrically bias the p-n junction diode relative to the substrate by a diode bias voltage of at least about 500 V to accelerate the backscattered electrons between the substrate and the p-n junction diode, and (c) a signal amplifier to process an input signal from the p-n junction diode and generate an output signal; and
a controller capable of determining the locations of one or more of the fiducial marks on the substrate from the output signal of the signal amplifier.

16. An apparatus according to claim 15 wherein the controller is capable of determining the locations of the fiducial marks from the intensity of the signal.

17. An apparatus according to claim 15 wherein the diode bias voltage is sufficiently high to accelerate the backscattered electrons to kinetic energies of at least about 5 keV.

18. An apparatus according to claim 15 wherein the diode bias voltage is sufficiently high to accelerate backscattered electrons having kinetic energies of from about 2 keV to about 4 keV to kinetic energies of from about 5 keV to about 7 keV.

19. An electron beam image registration method comprising:
(a) providing a substrate having fiducial marks;
(b) generating, modulating and scanning an electron beam across the substrate to register an electron beam image on the substrate, whereby at least some electrons are backscattered by the substrate;
(c) electrically biasing a p-n junction diode relative to the substrate by a diode bias voltage of at least about 500 V to accelerate backscattered electrons from the substrate to the p-n junction diode; and
(d) detecting a signal from the p-n junction diode and processing the signal to determine the locations of one or more of the fiducial marks on the substrate.

20. A method according to claim 19 wherein the diode bias voltage is sufficiently high to accelerate the backscattered electrons to kinetic energies of at least about 5 keV.

21. A method according to claim 19 wherein the diode bias voltage is sufficiently high to accelerate backscattered electrons having kinetic energies of from about 2 keV to about 4 keV to kinetic energies of from about 5 keV to about 7 keV.

22. A method according to claim 19 wherein the diode bias voltage is at least about 1000 V.

23. A method according to claim 22 wherein the diode bias voltage is less than about 10000 V.
